(19) United States
(12) Patent Application Publication
(10) Pub. No.: US 2017/0167246 A1
(43) Pub. Date: Jun. 15, 2017

(54) FLUID LOSS SENSOR

(71) Applicants: Naeem-Ur-Rehman Minhas, Romford (GB); Hasan Kesserwan, Al-Khobar (SA); Gaurav Agrawal, Aurora, CO (US); Asok J. Nair, Al-Khobar (SA)

(72) Inventors: Naeem-Ur-Rehman Minhas, Romford (GB); Hasan Kesserwan, Al-Khobar (SA); Gaurav Agrawal, Aurora, CO (US); Asok J. Nair, Al-Khobar (SA)

(73) Assignee: BAKER HUGHES INCORPORATED, Houston, TX (US)

(21) Appl. No.: 15/379,225

(22) Filed: Dec. 14, 2016

Related U.S. Application Data
(60) Provisional application No. 62/267,124, filed on Dec. 14, 2015.

(51) Int. Cl. E21B 47/10; G01F 15/06; E21B 47/12; E21B 21/08; E21B 47/06

(52) U.S. Cl. CPC E21B 47/10; E21B 21/08; E21B 47/06; E21B 47/065; E21B 47/12; G01F 15/06

(57) ABSTRACT

A system and method for estimating a fluid loss in a borehole while drilling are disclosed. A drill string disposed in the borehole. A first sensor of the drill string is configured to obtain a first fluid parameter measurement at a first location along the drill string. A second sensor of the drill string is configured to obtain a second fluid parameter measurement at a second location axially separated from the first location. A processor estimates a fluid loss along the drill string using the first fluid parameter measurement and the second fluid parameter measurement performs an action in response to the estimated fluid loss.

### CROSS REFERENCE TO RELATED APPLICATIONS

The present application claims priority to U.S. Provisional Application Ser. No. 62/267,124, filed Dec. 14, 2015, the contents of which are incorporated herein by reference in their entirety.

### BACKGROUND OF THE DISCLOSURE

Drilling operations in petroleum exploration include the use of a drill string that includes a drill bit for drilling a borehole in an earth formation. A drilling mud is used during the drilling operation and is circulated within the borehole to provide a lubrication to the drill bit as well as to circulate cuttings formed during the drilling process out of the borehole. However, various circumstances downhole, such as a rupture in the drill string, or leakage of the mud into the formation, can lead to a circulation loss or fluid loss. Such circulation losses are characterized by a rapid change in the pressure of the drilling mud and can have an adverse effect on the operation of the drill string. Consequences of these losses range from moderate to severe. In severe cases, drilling operations may be stopped, the well may be lost, blowouts may occur, or other costly possibilities. The present invention provides a method of monitoring the fluid loss within the borehole in order to take preventative action.

### SUMMARY OF THE DISCLOSURE

In one embodiment, a system for estimating a fluid loss in a borehole while drilling is provided, the system including: a drill string disposed in the borehole; a first sensor configured to obtain a first fluid parameter measurement at a first location along the drill string; a second sensor configured to obtain a second fluid parameter measurement at a second location axially separated from the first location; and a processor configured to estimate a fluid loss along the drill string using the first fluid parameter measurement and the second fluid parameter measurement and to perform an action in response to the estimated fluid loss.

In another embodiment, a method of estimating a fluid loss in a borehole while drilling is provided. The method includes: obtaining a first fluid parameter measurement at a first sensor located at a first location along a drill string disposed in the borehole; obtaining a second parameter measurement at a second sensor located at a second location along the drill string, wherein the second location is axially displaced from the first location; and using a processor to: estimate the fluid loss along the drill string using the first fluid parameter measurement and the second fluid parameter measurement, and perform an action in response to the estimated fluid loss.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows an exemplary drilling system of the present disclosure that includes a sensing mechanism for measuring a fluid pressure in a borehole;

FIG. 2 shows a detailed view of an exemplary joint between adjacent tubulars of the drill string of FIG. 1;

FIG. 3 shows a cross-sectional view of top end of the bottom tubular of FIG. 2 as viewed along line A-A.

FIG. 4 shows details of an exemplary sensing unit located at a joint between two tubulars which form part of the drill string;

FIG. 5 shows a flowchart illustrating one mode of operation for monitoring fluid loss; and

FIG. 6 shows a flowchart illustrating another mode of operation for determining fluid loss.

### DETAILED DESCRIPTION OF THE DISCLOSURE

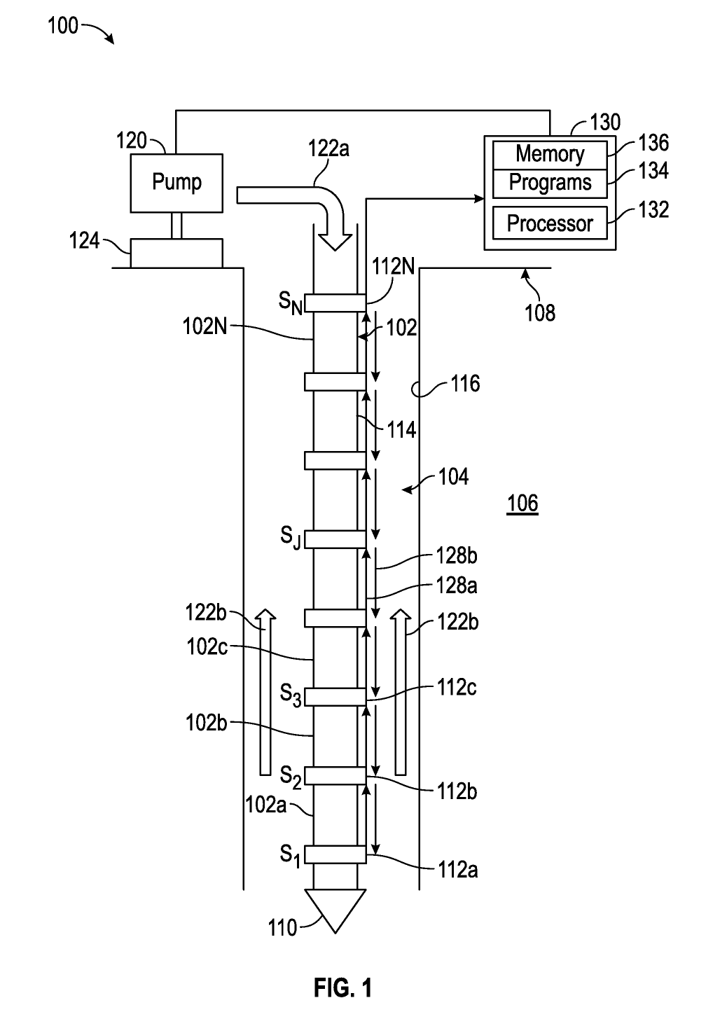

FIG. 1 shows an exemplary drilling system 100 of the present disclosure that includes a sensing mechanism for measuring a fluid parameter in a borehole. The system 100 monitors the fluid parameter in one embodiment. In another embodiment, the system 100 controls an operation of the system 100 or a component of the system 100 based on the monitored fluid parameter. The system 100 includes a drill string 102 disposed in a borehole 104 penetrating formation 106 and which drills the borehole 104. An outer surface 114 of the drill string 102 forms an annulus 105 with a wall 116 of the borehole 104. The drill string 102 extends into the borehole 104 from a surface location 108 and includes a drill bit 110 at a bottom end for drilling the borehole 104. The drill string 102 includes a plurality of tubulars 102ₐ, 102_{b}, 102_{c}, . . . , 102_{N} that are joined end to end to form the drill string 102. In various embodiments, each of the plurality of tubulars 102ₐ, 102_{b}, 102_{c}, . . . 102_{N} is approximately 30 feet (9.144 meters) in length and is adjoined to its adjacent tubular at a joint, such as joints (112ₐ, 112_{b}, 112_{c}, . . . 112_{N}). In one embodiment, the tubulars 102ₐ, 102_{b}, 102_{c}, . . . , 102_{N} are wired drill pipes

The drilling system 100 further includes a pump 120 at the surface location 108 that draws a fluid known as drilling mud from mud pit 124 and circulates the drilling mud throughout the borehole 104. The pump 120 introduces the drilling mud 122a into the drill string 102 at the surface location 108, and the drilling mud 122a travels downward through the drill string 102 to exit the drill string 102 at the drill bit 110. Drilling mud 122b then flows to the surface 108 through annulus 105 and is deposited at mud pit 124. Among other things, the drilling mud 122b carries rock cuttings from the drill bit 110 up through annulus 105 and out of the borehole 104.

The drilling system 100 further includes a control unit 130 which monitors and controls various aspects of the drilling system 100. For example, the control unit 130 monitors and controls various drilling parameters, such as weight-on-bit, rotation rate, etc. The control unit 130 can also control various operations of the pump 120, such as by turning the pump 120 on and/or off, by controlling a speed or rate at which the pump 120 pumps of the drilling mud 122a through the borehole 104, or by monitoring and controlling a circulation pressure of the pump 120. The control unit 130 includes at least a processor 132 and a memory storage device 134 with various programs 136 stored therein which enable the processor 132 to monitor and control the drilling parameter, pump 120, etc. using the methods disclosed herein.

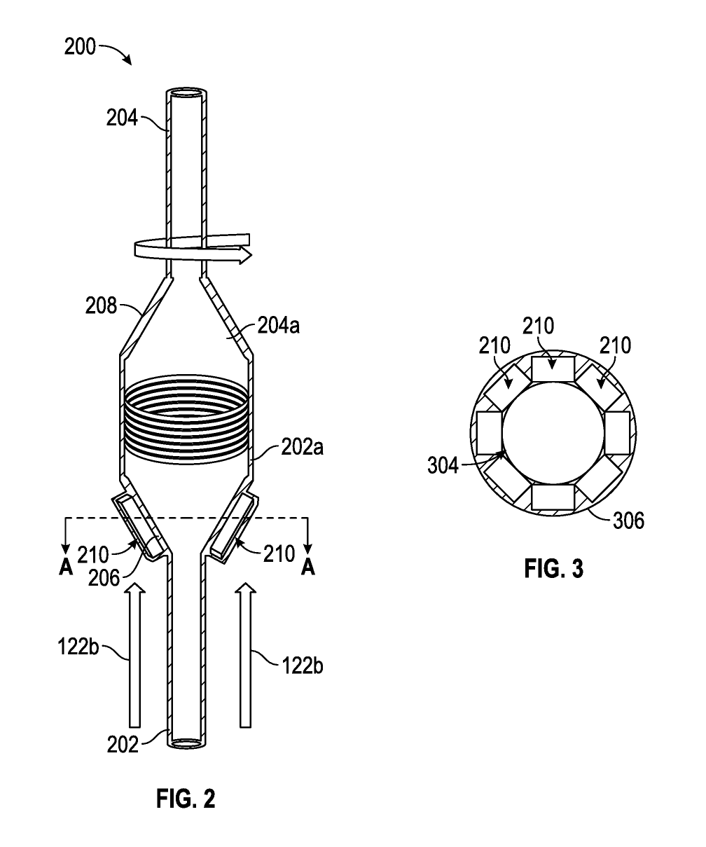

Joints 112ₐ, 112_{b}, 112_{c}, . . . , 112_{N} include sensing units S₁, S₂, S₃, . . . , S_{N}, respectively, which measure a parameter of the drilling mud 122b flowing outside of the drill string 102, i.e., in the annulus 105. In various embodiments, the fluid parameter can be a fluid pressure, a fluid temperature, a fluid flow rate, a chemical composition of the fluid, a concentration of a selected chemical in the fluid, etc. and the sensing units S₁, S₂, S₃, . . . , S_{N} can be sensors suitable for measuring the relevant parameter. Each of sensing units S₁, S₂, S₃, . . . , S_{N} has a unique or individually-assigned address, signature or identifier that can be used to identify the sensor to the other sensors along the drill string 102 and/or to processor 132. Each of sensing units S₁, S₂, S₃, . . . , S_{N} includes a transducer for sending and receiving differential signals along the drill string 102 to the next adjacent sensor, as indicated by signals 128a and 128b. The network of sensing units S₁, S_{z}, S₃, . . . , S_{N} can also transmit signals to surface processor 132 while drilling. In various modes of operation, the processor 132 uses the signals from the sensing units S₁, S₂, S₃, . . . , S_{N} to estimate a fluid floss and/or determine a location of fluid loss in the borehole 104 and takes an appropriate action, as discussed below. Joints 112ₐ, 112_{b}, 112_{c}, . . . 112_{N} and their related sensing units S₁, S₂, S₃, . . . , S_{N} are discussed in detail with respect to FIGS. 2-4.

FIG. 2 shows a detailed view of an exemplary joint 200 between adjacent tubulars of the drill string 102 of FIG. 1. A top end 202a of a first (bottom) tubular 202 and a bottom end 204a of a second (top) tubular 204 are shown connected together. The top end 202a of first tubular 202 includes a region which flares outward to accommodate various connection mechanisms, such as threaded surfaces that allow the end of one tubular to be screwed into the end of its adjoining tubular. The bottom end 204a of the second tubular 204 similarly flares outward. Therefore, the outer diameters of the ends 202a, 204a are greater than the outer diameter at the mid-sections of their respective tubulars 202, 204. In various embodiments, the difference between outer diameters at the ends 202a and 204a and the mid-sections of their respective tubulars is about 1 inch (about 2.54 centimeters). The first tubular 202 has an angled surface 206 caused by the flaring at the top end 202a. Similarly, second tubular 204 has an angled surface 208 caused by the flaring at the bottom end 204a. Sensors 210 are placed along the angled surface 206 in order to receive the drilling mud 122b as it travels uphole in the annulus (105, FIG. 1) thereby providing a desirable orientation for measuring a parameter the oncoming drilling mud 122b.

Although sensor 210 is shown attached to an outer surface of the first tubular 202 so as to be exposed directly to drilling mud 122b, in various embodiments, sensor 210 is located within a cavity or pocket formed at the flared end. For example, FIG. 3 shows a cross-sectional view 300 of top end 202a of the first tubular 202, as viewed along line A-A of FIG. 2. The flared top end 202a includes a central pipe 304 surrounded by sensors 210. An outer surface 306 of material surrounds the sensors 210 and protects the sensors 210 from coming into direct contact with the borehole wall, drill cuttings or other elements in the borehole 104 which might destroy or damage the sensors 210.

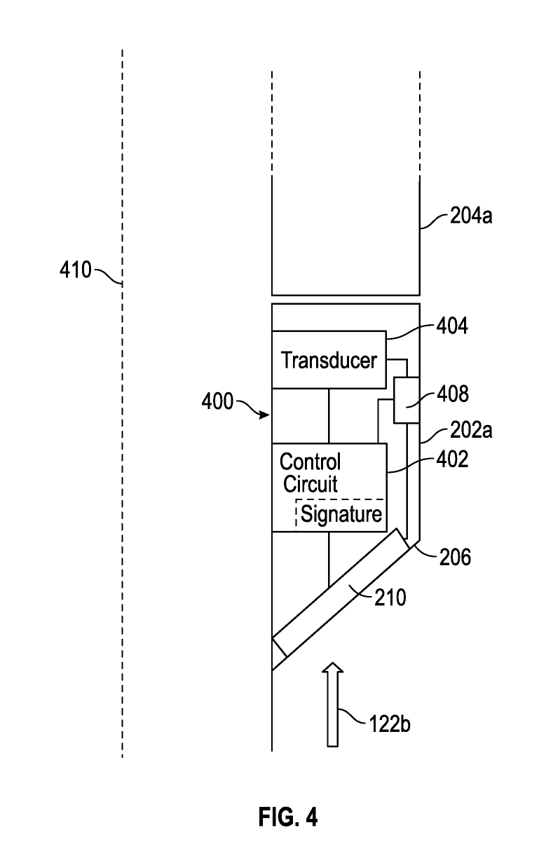

FIG. 4 shows details of an exemplary sensing unit 400 located at a joint between two tubulars, such as the first tubular 202 and second tubular 204, which form part of the drill string 102. Center line 410 of the drill string 102 is shown for illustrative purposes. In one embodiment, the sensing unit 400 is contained within top end 202a of first tubular 202. Sensing unit 400 includes the sensor 210, a local control circuit 402, a transducer 404 and a power supply 408. The sensor 210 is located at angled face 206 to receive the oncoming drilling mud 122b. Sensor 210 is in communication with control circuit 402 and sends signals to the control circuit 402 indicating a value of a fluid parameter measured at the sensor 210. Control circuit 402 is also in communication with transducer 404. The transducer 404 includes both a receiver and a transmitter. The control circuit 402 can activate the transducer 404 to send a signal uphole while drilling. Additionally, the transducer 404 can receive a signal that has been transmitted from another sensing unit on the drill string 102 and/or from the processor 132. The transducer 404 can then provide the received signal to the control circuit 402. In various embodiments, the transducer 404 can communicate its signals either via wired communication, wireless communication, a combination of wired and wireless communication, wired pipe telemetry, etc. In one embodiment, the transducer 404 communicates by transmitting an acoustic signal or acoustical vibration through tubulars 202 and 204. In other embodiments, the transducer 404 can send an electrical signal, a magnetic signal or an electromagnetic signal through tubulars 202 and 204. In yet another embodiment, the transducer 404 can send an electromagnetic wave through the fluid in the annulus 105 of the borehole 104 or a thermal signal.

Each sensing unit 400 has an assigned address, signature or identifier (e.g., an identification number) that uniquely identifies the sensing unit 400. A signal transmitted by the sensing unit 400 can include the identifier so that a device that receives the signal can identify the location from which the signal was generated or originated. The power supply 408 can be a battery, a continuous electric input, an energy harvesting device, etc., and provides power to sensor 210, local control circuit 402 and transducer 404.

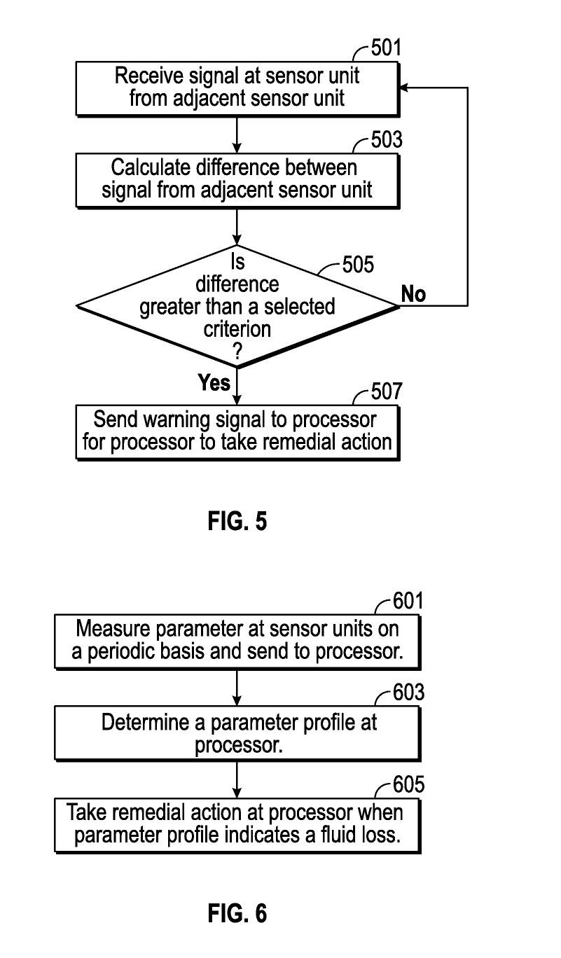

Returning to FIG. 1, sensing units S₁ and S₂ can be used to illustrate various modes of operation of the drilling system 100. The first sensing unit S₁ and the second sensing unit S₂ each include a sensor 210, local control circuit 402 and transducer 404 as shown in FIG. 4. In a first mode of operation (illustrated in FIG. 5), the sensing units S₁ and S₂ communicate signals along tubular 102ₐ in order to relay measured parameters to one another. The sensing units S₁, S₂ notify the processor 132 only when an anomaly in the parameter is determined. In an illustrative example, first sensing unit S₁ transmits a signal including parameter (P₁) and address of S₁ to the second sensing unit S₂ (Box 501). The transducer of the second sensing unit S₂ receives the signal and sends the signal to its associated control circuit 402. The control circuit 402 of S₂ reads the address from the received signal to determine that the signal is from the adjacent sensing unit (S₁). The control circuit 402 then receives a parameter (P₂) from its sensor and makes a decision based on a relation between the parameter values P₁ and P₂, such as a summation of the parameter values, a ratio of parameter values, a difference in parameter values, etc. In one embodiment, the control circuit 402 calculates a difference between the values of parameter P₁ and parameter P₂ (Box 503) and a decision is made (Box 505) based on the difference. If the difference is greater than a selected criterion, the control unit of the second sensing unit S₂ transmits a warning signal along the drill string 102 to processor 132 (Box 507). In one embodiment, the warning signal can include the difference in the parameter values. In another embodiment, the warning signal can include the difference in the parameter values as well as the parameter value measured at the sensor. A difference in parameter values greater than the selected criterion can indicate a loss of fluid between sensing units S₁ and S₂. Upon receiving the warning signal, the processor 132 can take a remedial action. For example, the processor 132 can turn off pump 120 or can reduce a speed or pressure of pump 120. The remedial action may be based on a downhole circumstance that may be indicated by the warning signal, such as a drill string rupture, mud leakage into the formation, etc., in order to prevent further consequences such as well loss, blowout, etc. Such actions can be based on an estimated fluid loss or a location of fluid loss determined by the processor 132. Returning to Box 505, when the difference between P₁ and P₂ is less than the selected criterion, the control circuit does not send a signal, as this is indicative of a normal flow of the drilling mud, but rather continues its downhole monitoring process at Box 501. The transmitting of signals from one sensing unit to another sensing unit and the subsequent comparison of parameter values can therefore occur on a periodic basis.

In another mode of operation shown in FIG. 6, each sensing unit S₁, S₂, . . . , S_{N} transmits a signal indicating the parameter values measured at the sensing units (along with sensors identifier) uphole to the processor 132, generally on a periodic basis (Box 601). In this mode, a sensing unit (e.g., sensing unit S₂) transmits its signal to processor 132. Also in this mode, sensing unit S₂ receives signals from downhole sensing units (e.g., parameter measurement P₁ from sensing unit S₁) and relays the signal to the next sensing unit (e.g., sensing unit S₃). Each sensing unit therefore relays the signals received from sensing units that are downhole until the signals are received at processor 132. The processor 132 can then determine a profile of the parameter (Box 603) along the borehole 104 and can determine when and where a change in the parameter occurs along the borehole 104 from the profile of the parameter. Since the sensing units have transmitted their identifiers to the processor 132, the zonal location of the change in the parameter values can be established at processor 132. Additionally, information on the magnitude and rate of fluid loss can be determined, thus giving information on the size of the loss channels. The processor 132 can then take any of the exemplary remedial actions discussed above when a fluid loss occurs (Box 605).

The processor 132 can also transmit mode control signals to the sensing units S₁, S₂, S₃, . . . , S_{N} to switch their mode of operation. In one embodiment, the sensitivity of the sensors can be set so that small changes in parameter values that precede an actual borehole fluid loss event can be detected and appropriate actions taken to prevent fluid loss in the borehole 104.

Set forth below are some embodiments of the foregoing disclosure:

### Embodiment 1

A system for estimating a fluid loss in a borehole while drilling, comprising: a drill string disposed in the borehole; a first sensor configured to obtain a first fluid parameter measurement at a first location along the drill string; a second sensor configured to obtain a second fluid parameter measurement at a second location axially separated from the first location; and a processor configured to estimate the fluid loss along the drill string using the first fluid parameter measurement and the second fluid parameter measurement and to perform an action in response to the estimated fluid loss.

### Embodiment 2

The system of embodiment 1, further comprising a control circuit at one of the first sensor and the second sensor.

### Embodiment 3

The system of embodiment 2, wherein the control circuit determines a difference between the first fluid parameter measurement and the second fluid parameter measurement and transmits a signal to the processor when the difference is greater than a selected criterion.

### Embodiment 4

The system of embodiment 2, wherein the control circuit is located at the first sensor and performs at least one of: (i) transmitting a signal from the first sensor to the processor; and (ii) receiving a signal from the second sensor and relaying the received signal to the processor.

### Embodiment 5

The system of embodiment 2, wherein the first sensor and the second sensor have individually-assigned identifiers, and signals transmitted by the first sensor and the second sensor include their assigned identifiers.

### Embodiment 6

The system of embodiment 1, further comprising a first transducer associated with the first sensor, wherein the first transducer communicates by one of: (i) wired communication; (ii) wireless communication; (iii) a combination of wired and wireless communication; and (iv) wired pipe telemetry.

### Embodiment 7

The system of embodiment 6, wherein the first transducer communicates by generating at least one of: (i) an acoustic pulse in the drill string; (ii) an electrical signal in the drill string; (iii) a magnetic signal in the drill string; (iv) an electromagnetic signal in the borehole; (v) a thermal signal and (vi) a vibration in the drill string.

### Embodiment 8

The system of embodiment 1, wherein the first fluid parameter measurement and the second fluid parameter measurement are measurements of a fluid flowing in an annular region between the drill string and a wall of the borehole.

### Embodiment 9

The system of embodiment 8, wherein the first sensor and the second sensor are angled to receive the fluid flowing in the annular region.

### Embodiment 10

The system of embodiment 1, wherein controlling the fluid loss includes at least one of: (i) turning off a pump that circulates a fluid in the borehole; (ii) reducing a speed of the fluid in the borehole; and (iii) reducing a circulation pressure of the fluid in the borehole.

### Embodiment 11

A method of estimating a fluid loss in a borehole while drilling, comprising: obtaining a first fluid parameter measurement at a first sensor located at a first location along a drill string disposed in the borehole; obtaining a second parameter measurement at a second sensor located at a second location along the drill string, wherein the second location is axially displaced from the first location; and using a processor to: estimate the fluid loss along the drill string using the first fluid parameter measurement and the second fluid parameter measurement, and perform an action in response to the estimated fluid loss.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system for estimating a fluid loss in a borehole while drilling, comprising:
a drill string disposed in the borehole;
a first sensor configured to obtain a first fluid parameter measurement at a first location along the drill string;
a second sensor configured to obtain a second fluid parameter measurement at a second location axially separated from the first location; and
a processor configured to estimate the fluid loss along the drill string using the first fluid parameter measurement and the second fluid parameter measurement and to perform an action in response to the estimated fluid loss.

2. The system of claim 1, further comprising a control circuit at one of the first sensor and the second sensor.

3. The system of claim 2, wherein the control circuit determines a difference between the first fluid parameter measurement and the second fluid parameter measurement and transmits a signal to the processor when the difference is greater than a selected criterion.

4. The system of claim 2, wherein the control circuit is located at the first sensor and performs at least one of: (i) transmitting a signal from the first sensor to the processor; and (ii) receiving a signal from the second sensor and relaying the received signal to the processor.

5. The system of claim 2, wherein the first sensor and the second sensor have individually-assigned identifiers, and signals transmitted by the first sensor and the second sensor include their assigned identifiers.

6. The system of claim 1, further comprising a first transducer associated with the first sensor, wherein the first transducer communicates by one of: (i) wired communication; (ii) wireless communication; (iii) a combination of wired and wireless communication; and (iv) wired pipe telemetry.

7. The system of claim 6, wherein the first transducer communicates by generating at least one of: (i) an acoustic pulse in the drill string; (ii) an electrical signal in the drill string; (iii) a magnetic signal in the drill string; (iv) an electromagnetic signal in the borehole; (v) a thermal signal and (vi) a vibration in the drill string.

8. The system of claim 1, wherein the first fluid parameter measurement and the second fluid parameter measurement are measurements of a fluid flowing in an annular region between the drill string and a wall of the borehole.

9. The system of claim 8, wherein the first sensor and the second sensor are angled to receive the fluid flowing in the annular region.

10. The system of claim 1, wherein controlling the fluid loss includes at least one of: (i) turning off a pump that circulates a fluid in the borehole; (ii) reducing a speed of the fluid in the borehole; and (iii) reducing a circulation pressure of the fluid in the borehole.

11. A method of estimating a fluid loss in a borehole while drilling, comprising:
obtaining a first fluid parameter measurement at a first sensor located at a first location along a drill string disposed in the borehole;
obtaining a second parameter measurement at a second sensor located at a second location along the drill string, wherein the second location is axially displaced from the first location; and
using a processor to:
estimate the fluid loss along the drill string using the first fluid parameter measurement and the second fluid parameter measurement, and
perform an action in response to the estimated fluid loss.

12. The method of claim 11, further comprising using a control circuit at one of the first sensor and the second sensor to calculate a difference between the first fluid parameter measurement and the second fluid parameter measurement and transmit a signal to the processor when the difference between the first fluid parameter measurement and the second fluid parameter measurement is greater than a selected criterion.

13. The method of claim 12, wherein transmitting the signal includes at least one of: (i) transmitting the difference between the first fluid parameter measurement and the second fluid parameter measurement; and (ii) transmitting one of the first parameter measurement and the second parameter measurement.

14. The method of claim 11, wherein the first sensor includes a control circuit, further comprising using the control circuit to perform at least one of: (i) transmitting a signal from the first sensor to the processor; and (ii) receiving a signal from the second sensor and relaying the received signal to the processor.

15. The method of claim 14, further comprising transmitting a signal from the control circuit that includes an identifier of one of the first sensor and the second sensor associated with the control circuit.

16. The method of claim 11, further comprising disposing the first sensor and the second sensor at an angle to receive a fluid flowing in an annulus outside the tool string.

17. The method of claim 11, wherein performing the action includes at least one of: (i) turning off a pump that circulates a fluid in the borehole; (ii) reducing a speed of the fluid in the borehole; and (iii) reducing a circulation pressure of the fluid in the borehole.

18. The method of claim 11, wherein the fluid parameter is at least one selected from the group consisting of: (i) a fluid pressure; (ii) a fluid temperature; (iii) a fluid flow rate; (iv) a chemical concentration of the fluid.

19. The method of claim 11, further comprising transmitting at least one of the first fluid parameter measurement and the second fluid parameter measurement via at least one of: (i) a wired communication; (ii) a wireless communication; (iii) a combination of wired and wireless communication; and (iv) wired pipe telemetry.

20. The method of claim 11, further comprising communicating along the drill string by generating at least one of: (i) an acoustic pulse in the drill string; (ii) an electrical signal in the drill string; (iii) a magnetic signal in the drill string; and (iv) an electromagnetic signal in the borehole; (v) a vibration in the drill string.

21. The method of claim 11, further comprising finding a location of the fluid loss along the drill string from the estimate of fluid loss.
